(19) United States
(12) Patent Application Publication
(10) Pub. No.: US 2013/0314282 A1
(43) Pub. Date: Nov. 28, 2013

(54) POSITIONING SYSTEM

(71) Applicants: Ute Marita Meissner, Koeln (DE); Klaus-Uwe Hahn, Wendeburg (DE)

(72) Inventors: Ute Marita Meissner, Koeln (DE); Klaus-Uwe Hahn, Wendeburg (DE)

(73) Assignee: DEUTSCHES ZENTRUM FUER LUFT- UND RAUMFAHRT E.V., Koeln (DE)

(21) Appl. No.: 13/989,427

(22) PCT Filed: Nov. 25, 2011
(86) PCT No.: PCT/EP2011/071029

§ 371 Date: Aug. 7, 2013

(30) Foreign Application Priority Data
Nov. 26, 2010 (DE) 10 2010 052 47531

(51) Int. Cl. G01S 5/08

(52) U.S. Cl. CPC G01S 5/08
USPC 342/461

(57) ABSTRACT

The invention relates to a ground-based positioning system for determining a location of a mobile object (1), comprising a plurality of fixed ground stations (2a-2c) respectively comprising a transmitting and/or receiving unit (3a-3c), and at least one transmitting and/or receiving unit (5) that is arranged on the object, the transmitting mils being set up so transmit position signals and the receiving units being set up to receive the position signals transmitted by the transmitting units. The ground-based positioning system comprises at least one position determination unit (4, 6) connected communicatively to at least some of the transmitting and/or receiving nuns (3a-3c, 5), said position determination unit (4, 6) being set up to determine distances between the fixed transmitting and/or receiving units (3a-3c) of the ground stations (2a-2c) and the at least one transmitting and/or receiving unit (5) arranged on the object (1), for determining at least one receiving angle of she received position signals on the respective receiving unit and for determining a relative speed between at least one of the fixed transmitting and/or receiving units (3a-3c) of the ground stations (2a-2c) and the at least one transmitting and/or receiving unit (5) arranged on the object (1), according to the position signals sent by the fixed transmitting units and received by the at least one receiving unit arranged ins the object, and/or sent by the at least one transmitting unit arranged on the object and received by the fixed receiving units, and for determining

The invention relates to a ground-based positioning system for determining a location of a mobile object. The invention also relates to a method therefor.

### PRIOR ART

In many actions being executed in an automated manner, determining the location is an essential component so that a process can be executed in a fully automated manner. However, this lastly does not relate only to automated action sequences but also any form of surveillance processes in which the location or the knowledge about one's own position forms an essential component of the process.

In the question of the manner in which the position is determined, two decisive criteria are ultimately of importance: accuracy and availability. The more safety-critical the corresponding application in this context, the higher the demands to be made of the accuracy or availability. Thus, for example, GNS (Global Navigation Satellite) systems such as, for example, the GPS have an almost gapless availability, apart from the circumstance of shading, whilst the accuracy depends on external boundary conditions and in general is not suitable for high-precision tasks including altitude information since the accuracy is not adequate in this case.

Thus, for example, corresponding flight management systems such as flight landing systems need highly accurate altitude information so that an aircraft can land safely at an airport fully automatically. This is not possible with the GPS known today even just because the highly accurate altitude information necessary for this purpose cannot be determined with the aid of such a satellite navigation system.

Thus, a landing system for aircraft in which a signal is emitted by a transmitting station installed on the ground, which signal is reflected by a transponder, which are normally needed for the secondary radar, arranged on the aircraft, is described, for example, in U.S. Pat. No. 6,469,654 B1. On the ground, there are some receiving units which receive the signal sent back by the transponder in order to be able to determine from this finally the position of the flying object on the ground. A similar principle, in which a transponder arranged on the aircraft is also used, is known from U.S. Pat. No. 5,017,930.

The great disadvantage in these systems, however, consists in that the processing time fluctuates in the transponder arranged on the aircraft and is not known by the system as such so that the signal transit time of the signal sent there, processed and sent back is subject to an inaccuracy which is attributable to the unknown processing time in the flying object itself. This results in an inaccuracy in determining distance which lastly results in an inaccuracy of the location of the aircraft.

### OBJECT

In this regard, it is the object of the present invention to specify an improved positioning system which can determine a highly accurate position of an object.

### ACHIEVEMENT

The object is achieved by the ground-based positioning system of the type initially mentioned for determining a location of a mobile object by means of a plurality of fixed ground stations which have in each case a transmitting and/or receiving unit, and by means of at least one transmitting and/or receiving unit fixed to the object, arranged on the object, the transmitting units being configured for transmitting position signals and the receiving units being configured for receiving the position signals emitted by the transmitting units and the ground-based positioning system having at least one position determination unit connected communicatively to at least some of the transmitting and/or receiving units, which is configured for determining distances between the fixed transmitting and/or receiving units of the ground stations and the at least one transmitting and/or receiving unit of the object, fixed to the object, for determining at least one receiving angle of the received position signals at the respective receiving unit and for determining a relative speed between at least one of the fixed transmitting and/or receiving units of the ground stations and the at least one transmitting and/or receiving unit of the object, fixed to the object, in dependence on the position signals which have been transmitted by the fixed transmitting units and received by the at least one receiving unit fixed to the object and/or which have been transmitted by the at least one transmitting unit fixed to the object and received by the fixed receiving units, the at least one position determination unit being configured for determining the location of the at least one transmitting and/or receiving unit fixed to the object in dependence on the distances determined, at least one of the receiving angles and at least one of the relative speeds determined.

The ground-based positioning system according to the invention has a number of ground stations in which a transmitting and/or receiving unit is arranged, the ground stations being spaced apart from one another adequately. In addition, at least one transmitting and/or receiving unit is located on a mobile object, the location of which is to be determined with the aid of the present ground-based positioning system. The transmitting units, whether arranged at the ground stations or on the object, are configured for emitting position signals, whilst the receiving units are configured for receiving such emitted position signals.

With the aid of a position determination unit which is connected communicatively to the transmitting and/or receiving units, the distance, the receiving angle and a relative speed of the object can be determined by means of the position signals received. In this context, the distance between the fixed transmitting and/or receiving unit and the transmitting and/or receiving unit fixed to the object can be determined preferably by means of the transit time of a signal from a transmitting unit to a receiving unit. The receiving angle can be determined advantageously with the aid of a number of receiving antennas arranged at the receiving units, the angle being determinable, for example, by means of a phase shift of the received signal at the receiving antennas. The relative speed lastly can be derived from a Doppler shift of the received position signal.

The position determination unit is then configured in such a manner that it can determine the position of the object especially in three-dimensional space highly accurately in dependence on the distance determined, the receiving angle and the relative speed determined. By combining the three measuring methods, the result of the position determination can then be considerably improved in terms of accuracy so that such a system would also be suitable for flight operation. Thus, for example, a first location can be determined with the aid of the distance measurement which can be approximated further with the aid of the receiving angle. With the aid of the relative speed, a movement or speed can be derived which is also used in determining the location for increasing the accuracy. Thus, it is conceivable, for example, that the results of all three results are combined to form one location with the aid of a statistical method.

In this context, the position determination unit is arranged on the object itself in a first alternative, for example, and connected to the receiving unit fixed to the object in such a manner that the position signals received by the receiving unit or the information derivable therefrom can be forwarded to the position determination unit. In this arrangement, the ground stations correspondingly have transmitting units which emit these position signals so that the object can determine its position independently and autonomously by means of these position signals emitted by the ground stations. Naturally, the locations of the fixed transmitting units arranged at the ground stations are known to the object or to the position determination unit, respectively, or are conveyed to the object with the aid of information which can be coded in the position signals as will still be explained later.

In a second alternative, the position determination unit is connected to the receiving units fixed to the object, arranged at the ground stations, whilst a corresponding transmitting unit for emitting position signals is arranged on the object. If the receiving units which are arranged at the ground stations arranged spaced apart from one another then receive this position signal emitted by the moving object, it is forwarded to the position determination unit from which the corresponding information can then be derived and the position of the object or of the transmitting unit at the object, respectively, can be calculated. In this alternative, it is thus possible that the position of an object can be determined by a central station or a corresponding ground station without requiring further equipment such as, for example, radar or the like for this purpose.

In a third alternative, the fixed ground stations arranged spaced apart from one another have in each case a transmitting and a receiving unit, whilst, on the object, at least one transmitting and receiving unit is also arranged. In addition, the fixed receiving units are in each case connected to a position determination unit, whilst, on the object, a position determination unit is also arranged which is connected to the local receiving unit. In this alternative embodiment, which determines the location both of the object itself and of the ground units, so that the object does not only know its location itself but the position can also be determined by others outside the object. In this alternative, the position of the object can be determined both by the object and by the ground station independently of one another which increases the fault tolerance and simplifies the fault diagnostics considerably as will still be described further below.

In all three alternatives, the location of the object is thus determined highly accurately with the aid of the measuring methods used as a basis so that it can now be used for further applications. Thus, it is conceivable, for example, that aircraft are supported in flight management with the aid of such a ground-based positioning system. It is also conceivable, however, that the highly accurate position of traction vehicles or wagons can thus be determined in marshaling yards. Another application would be conceivable in the context of narrow harbor inlets at which the position of ships or other watercraft is to be determined highly accurately.

If, for example, more than one transmitting and/or receiving unit is arranged on the object spaced apart from one another, for example for redundancy purposes, it is particularly advantageous if the highly accurate location is determined for each of the transmitting and/or receiving units fixed to the object, the spatial position of the object then being derivable from the individual locations. This is because, if the relative spacing of the transmitting and/or receiving units on the object is known, the spatial position can be derived on the basis of the different locations of the transmitting and/or receiving units on the object with the aid of the relative distance of the corresponding units from one another.

The fixed transmitting units which are arranged at the ground stations are connected advantageously to a control unit which is configured for synchronously emitting the position signals by means of the transmitting units. In this context, the signal transit times from the control unit to the spaced ground stations can be compensated for since they are already known. The synchronization of emitting these position signals can thus be increased considerably which increases the accuracy of the position determination. This is because it is of decisive significance in the determination of the distance by means of the signal transit time that the transmitting units emit their position signals synchronously in such a manner that the receiving unit can determine the signal transit time as accurately as possible.

To safeguard the fault tolerance or the guarantee of reliable operation, it is particularly advantageous if the ground-based positioning system is configured in such a manner that it can verify the operation of the fixed transmitting and/or receiving units. For this purpose, the fixed receiving units are configured at the ground stations in such a manner that they also receive the position signals which are emitted by the respective other transmitting units of the respective other ground stations and can thus verify the operation of the individual transmitters of the ground stations in dependence on these received position signals. Thus, it is conceivable, for example, that the position determination unit which is connected to the fixed receiving units determines the position of the ground station by means of these position signals emitted by the fixed transmitters and verifies the operation of the positioning system by means of these locations of the ground station thus determined in that the locations determined are compared with the known highly accurate location of the ground station. Thus, malfunctions, but also corresponding interference transmitters having a criminal background can be reliably detected early.

However, it is also conceivable and particularly advantageous if the operation of the ground-based positioning system is verified in such a manner that both the locations determined by the object and those determined by the ground station are compared (alternative 3). If this results in great deviations, it is possible to derive from this that a malfunction of the system is present here which requires the fastest possible response. In this context, the locations can be exchanged with the aid of a normal positioning system. Naturally, it is especially advantageous in this context if the locations determined are coded with just these position signals as data when emitting position signals again, the corresponding opposite station (receiving unit) being able to extract corresponding useful data from these position signals so that the location also transmitted can be compared with a determined location.

It is especially advantageous then if, as already indicated above, the transmitting units are configured for coding information into the position signals and for emitting these position signals. If the corresponding information is available to the transmitting unit, corresponding information can thus be coded into these position signals which, as soon as they have been received by the receiving unit, can then be extracted by the latter. This type of information transmission is conceivable both from the object to the ground stations and from the ground stations to the object and enables information to be exchanged without occupying further capacities.

Thus, for example, flight points or corresponding flight information can be transmitted in the case of flying objects. However, it is also conceivable that the location determined shortly before in each case is coded along with the next emission of the position signals so that a comparison can be performed between the locations which are determined by the object and those which are determined by the ground stations.

Advantageously, a carrier frequency which is not used by the known GNS systems is selected for emitting the position signals so that no mutual interference can occur and these systems can be used additionally to the ground-based positioning system according to the invention in the case of doubt.

The object of the present invention is also achieved by means of the method of the type initially mentioned, comprising the steps:
emitting position signals by means of a number of fixed transmitting units arranged on the ground and receiving the position signals by means of at least one receiving unit, fixed to the object, arranged on the object, and/or emitting position signals by means of at least one transmitting unit arranged on the object and receiving the position signals by means of a number of fixed receiving units arranged on the ground,
determining distances between the fixed transmitting and/or receiving units and the at least one transmitting and/or receiving unit fixed to the object, a receiving angle of the received position signals at the respective receiving unit and a relative speed between at least one of the fixed transmitting and/or receiving units and the at least one transmitting and/or receiving unit fixed to the object in dependence on the received position signals, and
determining a location of at least one object of the transmitting and/or receiving unit in dependence on the distances determined, the at least one receiving angle and the at least one relative speed.

Advantageous embodiments of the method according to the invention are found in the corresponding subclaims.

The invention will be explained in greater detail by way of an example, using the attached drawing, in which:

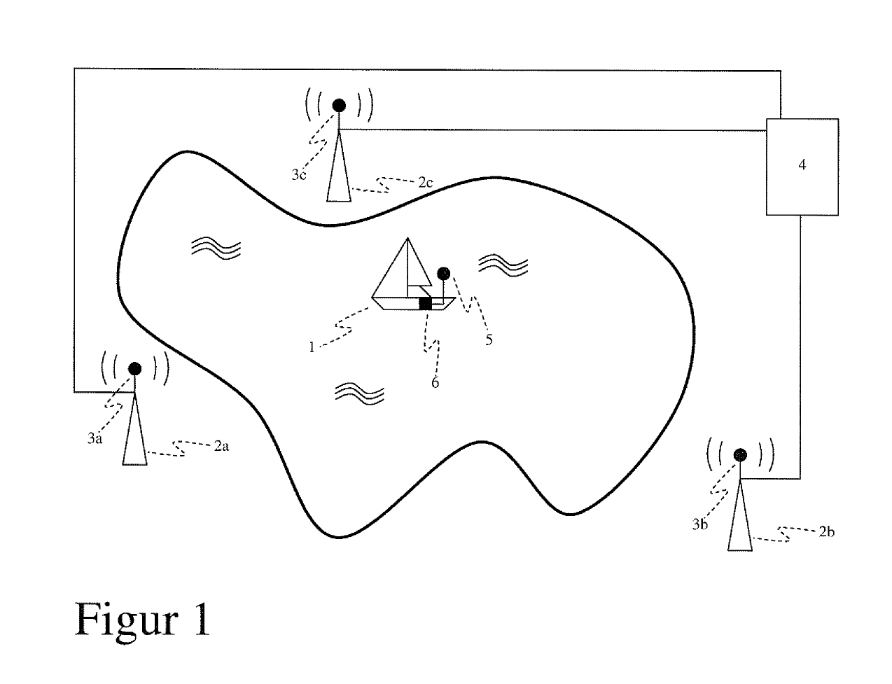

FIG. 1 shows a diagrammatic representation of a ground-based positioning system using the example of a watercraft.

FIG. 1 shows diagrammatically the ground-based positioning system according to the invention, by means of which a watercraft 1 is to be located in the exemplary embodiment of FIG. 1, i.e. the position of the watercraft 1 is to be determined. Naturally, other applications are also conceivable so that the range of application is not restricted to the exemplary embodiment 1.

In the vicinity of a water area, there is a number of ground stations 2a to 2c, which in each case have a transmitting and/or receiving unit 3a to 3c. The receiving units 3a to 3c are connected to a position determination unit 4 arranged on the ground and in the vicinity of the ground station 3a to 3c.

On the watercraft 1, a transmitting and/or receiving unit 5 fixed to the object is additionally arranged which is connected communicatively to a position determination unit 6 fixed to the object.

In the exemplary embodiment of FIG. 1, position signals are then emitted by the fixed transmitting units 3a to 3c which can be received by the receiving unit 5 fixed to the object of the watercraft 1. With the aid of the position determination unit 6 fixed to the object, the distance from the respective transmitting unit 3a to 3c is then determined in dependence on the signal transit time of each position signal which is emitted by the transmitting units 3a to 3c. The respective receiving angle is also determined for each position signal of the fixed transmitting units 3a to 3c with the aid of a number of receiving antennas arranged at the receiving unit, the receiving angles determined then being forwarded to the position determination unit 6. If the object moves, the relative speed of the watercraft with respect to each transmitting unit 3a to 3c can finally also be determined with respect to each fixed transmitting unit 3a to 3c by means of a Doppler shift of the position signals. This information, too, is forwarded to the position determination unit 6.

From the combination of these three measurement results, the position of the receiving unit 5 fixed to the object can then be determined highly accurately, it then being possible to infer the position of the object by means of the highly accurate location of the receiving unit 5.

In addition, the reverse case is also conceivable that a position signal is emitted by the transmitting and/or receiving unit 5 which is received by the fixed receiving units 3a to 3c. From this position signal received by the fixed receiving units 3a to 3c, too, the distance, the receiving angle and a possible relative speed can be determined which are either determined in the position determination unit 4 or forwarded to it so that the location of the transmitting unit 5 of the watercraft 1 can be determined from this from the combination of the results of the determination.

In the third alternative already mentioned, the positioning system can also be extended in that a location is determined in each case both by the position determination unit 6 which is arranged on the watercraft 1 and at the fixed position determination unit 4 which is connected to the fixed transmitting and/or receiving units 3a to 3c, which locations can then be compared with one another, for example, for the purpose of verification. This allows the accuracy and the fault tolerance of the system to be increased.

Advantageously, information can also be forwarded correspondingly with the aid of the position signals so that this does not necessarily require further radio systems. If, for example, a location of the receiving unit 5 has been determined by the position determination unit 6 fixed to the object, this location can be coded in the position signal with the repeated emission of a position signal by the fixed receiving units 3a to 3c which can then be extracted correspondingly as soon as they have been received. By means of the position signals just received, the location is then determined with the aid of the fixed position determination unit 4 and compared with the locations all contained in the position signal so that the position determination unit 4 has both knowledge about the locations determined by itself and the locations determined by the watercraft 1. A comparison of both locations with have been determined in different ways increases the accuracy and fault tolerance.

In another exemplary embodiment, for example in the case of an aircraft, waypoints or air lanes which are to be flown by the aircraft can be specified with the aid of this information.

The complete record of such a position signal is advantageously as short as possible so that the position data receivers, after being disconnected, can be reinitialized again within the shortest time. In addition, a higher rate of determination can be achieved by increasing the transmitting frequency which also increases advantageously the rate of useful data to be transmitted.

1. A ground-based positioning system for determining a location of a mobile object by means of a plurality of fixed ground stations which have in each case a transmitting and/or receiving unit, and by means of at least one transmitting and/or receiving unit fixed to the object, arranged on the object, the transmitting units being configured for transmitting position signals and the receiving units being configured for receiving the position signals transmitted by the transmitting units and the ground-based positioning system having at least one position determination unit, connected communicatively to at least some of the transmitting and/or receiving units, which is configured for determining distances between the fixed transmitting and/or receiving units of the ground stations and the at least one transmitting and/or receiving unit of the object, fixed to the object, for determining at least one receiving angle of the received position signals at the respective receiving unit and for determining a relative speed between at least one of the fixed transmitting and/or receiving units of the ground stations and the at least one transmitting and/or receiving unit of the object, fixed to the object, in dependence on the position signals which have been transmitted by the fixed transmitting units and received by the at least one receiving unit fixed to the object and/or which have been transmitted by the at least one transmitting unit fixed to the object and received by the fixed receiving units and which is configured for determining the location of the at least one transmitting and/or receiving unit fixed to the object in dependence on the distances determined, at least one of the receiving angles and at least one of the relative speeds determined.

2. The ground-based positioning system as claimed in claim 1, wherein the positioning system has at least two transmitting and/or receiving units fixed to the object, arranged on the object, which are arranged to be spaced apart from one another, the position determination unit being configured for determining the spatial position of the object in dependence on the locations of the respective transmitting and/or receiving units.

3. The ground-based positioning system as claimed in claim 1, wherein the position determination unit is configured for determining the distance between the fixed transmitting and/or receiving units of the ground station and the transmitting and/or receiving unit fixed to the object in dependence on the signal transit time of the position signals.

4. The ground-based positioning system as claimed in claim 1, wherein at least one receiving unit has a plurality of receiving antennas and the position determination unit is configured for determining the receiving angle of a position signal, received by the receiving antennas, in dependence on the receiving antennas.

5. The ground-based positioning system as claimed in claim 1, wherein the position determination unit is configured for determining the relative speed between the at least one transmitting and/or receiving unit of the ground station and the at least one fixed transmitting and/or receiving unit in dependence on a Doppler shift of the received position signals.

6. The ground-based positioning system as claimed in claim 1, wherein the fixed transmitting units or those fixed to an object are connected to a control unit which is configured for synchronously emitting the position signals by means of the connected transmitting units.

7. The ground-based positioning system as claimed in claim 1, wherein the fixed receiving units fixed to the object are designed for receiving the position signals emitted by the fixed transmitting units fixed to the object and the position determination unit connected communicatively to the fixed receiving units fixed to the object is configured for verifying the operation of the transmitting and/or receiving units in dependence on the received position signals of the fixed transmitting units fixed to the object.

8. The ground-based positioning system as claimed in claim 1, wherein the positioning system is configured for verifying the operation in dependence on a comparison between the location which has been determined by means of the position signals received by the receiving units fixed to the object and the location which has been determined by means of the position signals received by the fixed receiving units.

9. The ground-based positioning system as claimed in claim 1, wherein the transmitting units are configured for coding information into the position signals and for emitting such position signals and the receiving units are configured for receiving such position signals and for extracting the information coded into the position signals.

10. A method for ground-based positioning by determining a location of an object, comprising the steps:
emitting position signals by means of a number of fixed transmitting units arranged on the ground and receiving the position signals by means of at least one receiving unit, fixed to the object, arranged on the object, and/or emitting position signals by means of at least one transmitting unit arranged on the object and receiving the position signals by means of a number of fixed receiving units arranged on the ground,
determining distances between the fixed transmitting and/or receiving units and the at least one transmitting and/or receiving unit fixed to the object, a receiving angle of the received position signals at the respective receiving unit and a relative speed between at least one of the fixed transmitting and/or receiving units and at least one transmitting and/or receiving unit fixed to the object in dependence on the received position signals, and
determining a location of the at least one transmitting and/or receiving unit, fixed to the object, in dependence on the distances determined, the at least one receiving angle and the at least one relative speed.

11. The method as claimed in claim 10, characterized by determining a spatial position of the object in dependence on the location of at least two transmitting and/or receiving units spaced apart from one another, arranged on the objects.

12. The method as claimed in claim 10, characterized by determining the distance between transmitting and/or receiving unit in dependence on a signal transit time of the position signals.

13. The method as claimed in claim 10, characterized by determining the relative speed between transmitting and receiving unit in dependence on a Doppler shift of the received position signals.

14. The method as claimed in claim 10, characterized by receiving position signals emitted by means of the fixed transmitting units, fixed to the object, by the receiving units arranged on the ground and verifying the operation of the transmitting and/or receiving units in dependence on the received position signals.

15. The method as claimed in claim 10, characterized by verifying the operation in dependence on a comparison between the location which was determined by means of the position signals received by receiving units fixed to the object, and the location which was determined by means of the position signals received by the fixed receiving units.

16. The method as claimed in claim 10, characterized by coding information into the position signals and emitting such position signals by means of the transmitting unit and receiving such position signals by means of the receiving unit and extracting the coded information from the position signals.
